(19) United States
(12) Patent Application Publication
(10) Pub. No.: US 2005/0149945 A1
(43) Pub. Date: Jul. 7, 2005

(54) Method and system of re-reserving object locks without causing reservation thrash

(76) Inventor: James M. Stichnoth, San Jose, CA (US)

Correspondence Address: LAWRENCE CHO;C/O PORTFOLIOIP, P. O. BOX 52050, MINNEAPOLIS, MN, 55402, US

(21) Appl. No.: 10/746,010

(22) Filed: Dec. 24, 2003

(51) Int. Cl. G06F 3/00

(52) U.S. Cl. 719/316

(57) ABSTRACT

A runtime environment is described that includes a locking module to reserve a lock of an object among a plurality of reserved states when an external thread wants to access the object, and to unreserve the lock to an unreserved state when another external thread wants to access the object. The runtime environment further includes a lock re-reservation module to re-reserve the lock from the unreserved state to a first reserved state when the lock is in the unreserved state. A method of re-reserving a lock of an object is also described.

### TECHNICAL FIELD

Embodiments of the present invention pertain to compilation and execution of software programs. More specifically, embodiments of the present invention relate to a method and system of re-reserving object locks without causing reservation thrash.

### BACKGROUND

Runtime environments (also referred to as runtime systems or virtual machines) allow software programs in source code format to be executed by a target execution platform (i.e., hardware and operating system of a computer system) in a platform-independent manner. With a runtime environment, source code instructions are statically compiled into an intermediate language (e.g., byte-code) by a compiler and the intermediate language may then be further compiled by a just-in-time (JIT) compiler within the runtime environment into machine code that can be executed by the target execution platform.

To improve overall productivity, many dynamic programming languages (e.g., Java and Common Language Infrastructure) and their supporting runtime environments provide infrastructure that enables concurrent programming techniques (e.g., multi-threading) to be employed. In particular, many dynamic programming languages provide synchronization operations that enable multiple concurrent threads of execution to share or access a given object and its variables without causing a conflict or contention. For example, when a software designer knows that conflict or contention may occur during runtime for a globally accessible object (i.e., public object), the software designer typically includes appropriate synchronization operations (e.g., locking the object for the acquiring thread) within the object to prevent such a conflict or contention. In this manner, the software designer can guarantee that the globally accessible object is “thread safe”.

However, one problem of the above-described synchronization scheme is that the processing overhead associated with object synchronization typically results in a significant reduction in execution time. For example, for some well-known Java applications and benchmarks, synchronization overhead may consume approximately twenty percent of overall execution time. Another problem is that the synchronization is typically employed as a safeguard to prevent contentions during runtime (particularly in the case of object libraries), regardless of whether such synchronization is actually required during runtime.

Known escape analysis techniques can be used to remove certain unnecessary synchronizations by employing a whole program analysis to prove statically (i.e., at compile time) that certain synchronizations are unnecessary because the locked object is local to a thread. However, known escape analysis techniques cannot eliminate unnecessary synchronization for those objects that are ultimately visible to several threads but only ever locked by a single thread.

Another prior solution is through lock reservation. Employing this scheme, it can be dynamically (i.e., at runtime) decided that a substantially faster and cost-effective locking sequence be employed if an object is repeatedly locked by the same thread with no other threads attempting to lock the object (i.e., acquire the lock of the object) in the meantime, thus reducing the synchronization time and overhead. During this period, the object's lock is reserved by that locking thread. When a second thread attempts to acquire the lock of the object for the first time, the lock is changed to an unreserved state (meaning it is not reserved by any thread), and further locking attempts by any thread will use a slower and more expensive locking sequence.

The problem with the prior lock reservation scheme is that as soon as the second thread attempts to acquire the lock of the object, the lock becomes unreserved for the remainder lifetime of the object. This means that the fast locking sequence is no longer available.

Thus, there exists a need for a method and system of re-reserving object locks.

### BRIEF DESCRIPTION OF THE DRAWINGS

The features and advantages of embodiments of the present invention are illustrated by way of example and are not intended to limit the scope of the embodiments of the present invention to the particular embodiments shown.

FIG. 1 is a block diagram showing an exemplary architecture that compiles and executes a software program in source code format, wherein the architecture includes a runtime environment within which one embodiment of the present invention is implemented.

FIG. 2 is a block diagram of the runtime environment of FIG. 1 that includes a locking module and a lock re-reservation module that implements one embodiment of the present invention.

FIG. 3 is a flowchart diagram showing the locking and lock reservation process of the locking module of FIG. 2.

FIG. 4 is a flowchart diagram showing the lock re-reservation process of the lock re-reservation module of FIG. 2 in accordance with one embodiment of the present invention.

FIG. 5 shows the layout of a lock-word within a header of an object that can be accessed by the locking module and the lock re-reservation module of FIG. 2.

FIG. 6 is a state diagram of state transitions among various lock reservation states.

FIG. 7 is a diagram showing the state-by-state comparison between a lock state transition flow implemented with the lock re-reservation module of FIG. 2 in accordance with one embodiment of the present invention and a lock state transition flow implemented without the lock re-reservation module of FIG. 2.

### DETAILED DESCRIPTION

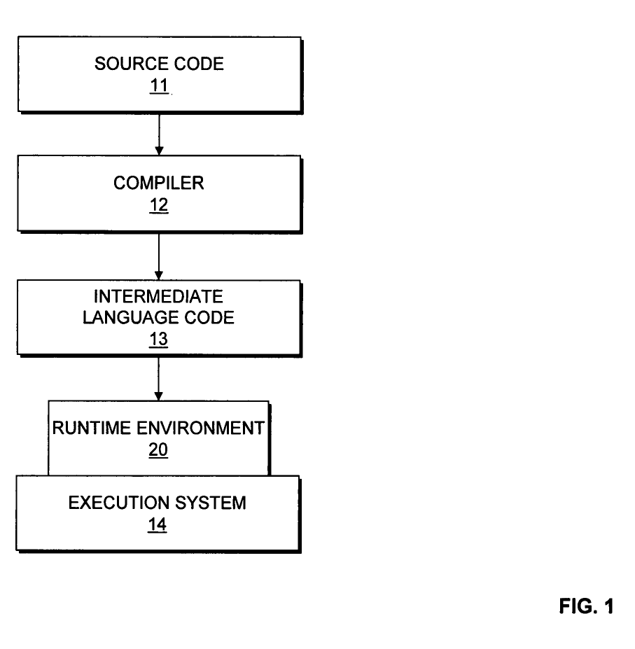

FIG. 1 shows a software program compilation and execution system that includes a compiler 12, a runtime environment 20 (also referred to as runtime system or virtual machine), and an execution system 14, in accordance with one embodiment of the present invention. Alternatively, the software program compilation and execution system may include more elements, modules, subsystems, or components than those described above.

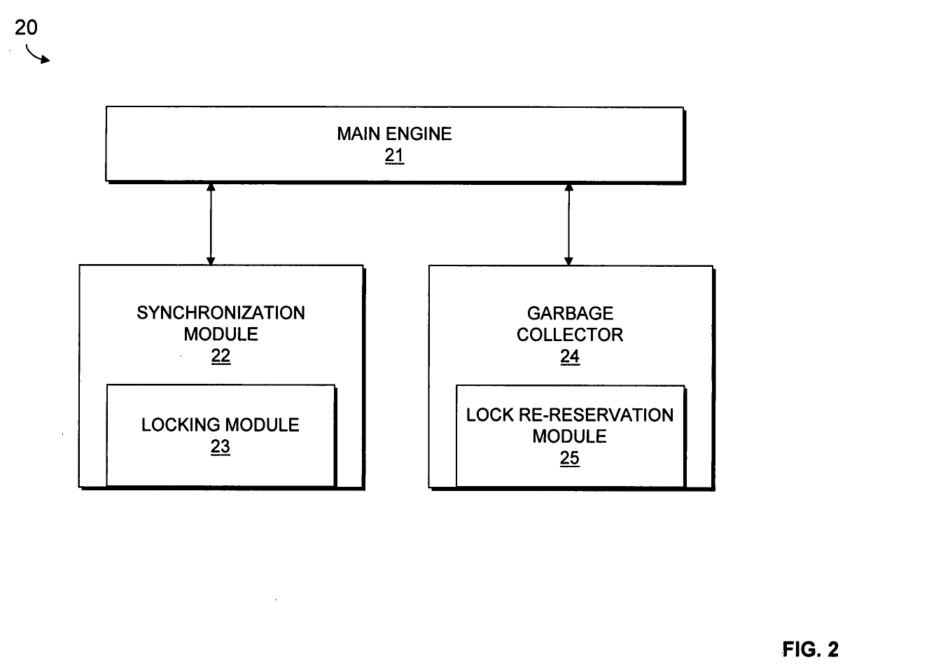

The runtime environment 20 implements one embodiment of the present invention. FIG. 2 shows in more detail the runtime environment 20 that includes a locking module 23 and a lock re-reservation module 25. In one embodiment, the locking module 23 is located within a synchronization module 22 of the runtime environment 20 and the lock re-reservation module 25 is located within a garbage collector 24 of the runtime environment 20. In accordance with one embodiment of the present invention, the lock re-reservation module 25 permits any object lock to move from an unreserved state to one of a number of reserved states (e.g., anonymously reserved state). This allows a fast and inexpensive locking sequence to continually be available to the locking module 23 even after the object has moved to the unreserved state.

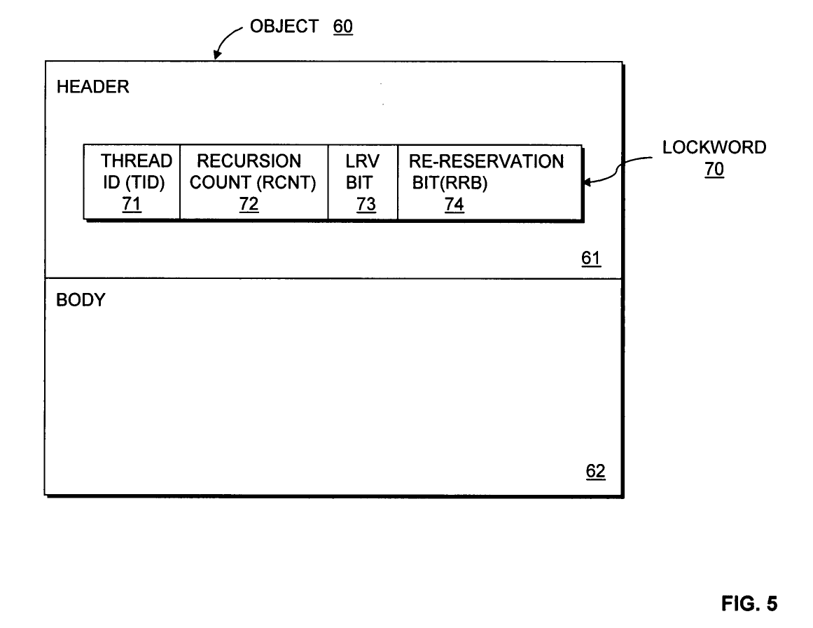

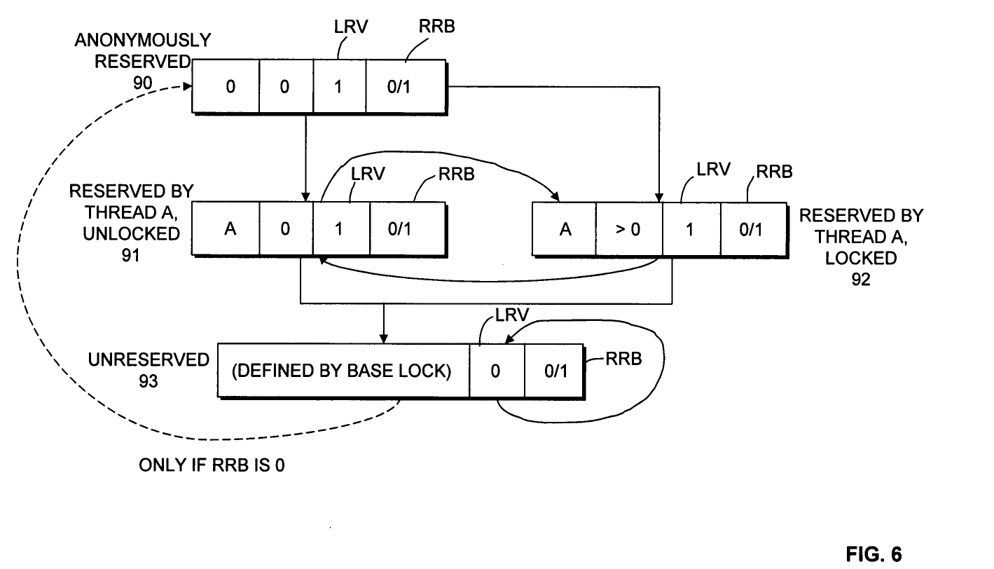

As will be described in more detail below, the locking module 23 is employed to lock an object (e.g., the object 60 in FIG. 5). In addition, the locking module 23 reserves the lock of the object among a set of reserved states (e.g., anonymously reserved state 90, reserved-but-not-locked state 91, reserved-and-locked state 92 in FIG. 6) when a thread of execution wants to access the object, and moves the lock to an unreserved state (e.g., unreserved state 93 in FIG. 6) when another thread attempts to access the reserved object. When the object is in any of the reserved states, the locking module 23 can lock the object (or acquire the lock of the object) using the fast and inexpensive locking sequence. When the object is in the unreserved state, the locking module 23 can only lock the object using a slow and expensive base locking sequence. The locking module 23, however, cannot move the lock from the unreserved state to any of the reserved states.

In accordance with one embodiment of the present invention, the lock re-reservation module 25 is used to re-reserve the lock from the unreserved state to a first reserved state (e.g., the anonymously reserved state 90) such that the fast and inexpensive locking sequence can continue to be available to the locking module 23 during the object's lifetime, even after the object has moved to the unreserved state. To perform the lock re-reservation, the lock re-reservation module 25 first determines whether the lock has moved from one of the reserved states to the unreserved state. If the lock has moved to the unreserved state, then the lock re-reservation module 25 re-reserves the lock from the unreserved state to the anonymously reserved state.

In order to avoid reservation thrash that is caused, for example, by numerous re-reservations of the lock due to multiple threads repeatedly attempting to lock the object, a re-reservation indication (e.g., the re-reservation bit (RRB) 74 in FIG. 5) is provided to indicate whether the lock has already been re-reserved or not. If the lock has been re-reserved (i.e., the re-reservation indication is set), then the lock re-reservation module 25 does not perform any re-reservation operation even if the lock is determined to be in the unreserved state. In other words, to perform the lock re-reservation, the lock re-reservation module 25 first determines whether (1) the lock has been moved from one of the reserved states to the unreserved state and (2) the re-reservation indication of the lock has been set. If (1) the lock has moved to the unreserved state and (2) the re-reservation indication of the lock has been not set, then the lock re-reservation module 25 re-reserves the lock from the unreserved state to the anonymously reserved state. Otherwise, the lock re-reservation module 25 does not move the lock out of the unreserved state. This prevents any reservation thrash from occurring.

To allow for the lock to receive multiple re-reservations without causing any reservation thrash, the lock re-reservation module 25 periodically resets the re-reservation indication after certain predetermined number of garbage collection cycles since the latest re-reservation phase. The latest re-reservation phase refers to the last completed lock re-reservation operation performed by the lock re-reservation module 25. This reset operation can be done by having the lock re-reservation module 25 determine if the object has gone through that predetermined number of garbage collection cycles (e.g., twenty garbage collection cycles) since the latest re-reservation phase. If the object has gone through the predetermined number of garbage collection cycles since the latest re-reservation phase, the lock re-reservation module 25 resets the re-reservation indication of the lock. The re-reservation indication does not affect the operation of the locking module 23 during lock reservation because the locking module 23, when reserving and unreserving the lock, does not consider the re-reservation indication at all. The re-reservation indication may be a one-bit indication (e.g., the RRB 74 in FIG. 5) within the lock-word (e.g., the lock-word 70 in FIG. 5) of the object or a one-bit indication within a header (e.g., the header 61 in FIG. 5) of the object. The lock re-reservation module 25 and its operations in accordance with one embodiment of the present invention will be described in more detail below, also in conjunction with FIGS. 1-7.

As can be seen from FIG. 1, the compiler 12 compiles a source code program 11 into an intermediate language code 13. The source code program 11 is a multi-threaded application program written in one of Dynamic Programming Languages (DPLs). The DPLs are also platform-independent programming languages, and can also be referred to as Object-Oriented Programming Languages (OOPLs). This means that the source code program 11 may include many small, reusable sections of program code known as “objects”. The objects, once created, can be quickly and easily combined and re-used to create new programs.

In one embodiment, the DPL is Java (developed by Sun Microsystems, Inc.). In another embodiment, the DPL is a programming language that is conformed to CLI (Common Language Infrastructure). CLI is developed by Microsoft Corporation from Redmond, Wash. for its .NET technology, and has become an ISO (International Organization for Standardization) standard (i.e., ISO/EEC 23271), which was published jointly by ISO and the International Electro-technical Committee (IEC) on Apr. 2, 2003 and entitled “Information technology—Common Language Infrastructure”.

The compiler 12 compiles the source code program 11 to generate the intermediate language code 13. The compiler 12 can be implemented using known technology. The compiler 12 is a software system and is run on a computer system (not shown).

The intermediate language code 13 is stored in a memory (not shown) of a computer system. When the source code program 11 is written in, for example, Java, the intermediate language code 13 is Java byte-code. If, however, the source code 11 is written in a programming language conformed to CLI, then the intermediate language code 13 is a CIL (Common Intermediate Language) code.

The runtime environment 20 further compiles the intermediate language code 13 into native code. The runtime environment 20 operates on and is hosted by the execution system 14. The execution system 14 also executes the native code. The term native code means machine code that is particular to a specific architecture or platform. The execution system 14 employs the runtime environment 20 to help further compile the intermediate language code 13 into native code that is platform-specific (or architecture-specific) to the execution system 14 and execute the native code. As described above, the runtime environment 20 can also be referred to as a virtual machine or runtime system.

The execution system 14 can be, for example, a personal computer, a personal digital assistant, a network computer, a server computer, a notebook computer, a workstation, a mainframe computer, or a supercomputer. Alternatively, the execution system 14 can be of any other electronic system with data processing capabilities. The intermediate language code 13 may be delivered to the execution system 14 via a communication link such as a local area network, the Internet, or a wireless communication network.

The execution system 14 includes an operating system (not shown in FIG. 1) and system-specific hardware (also not shown in FIG. 1). The operating system can be an open standard Linux operating system or other type of operating system. The system-specific hardware of the execution system 14 can be any hardware that includes all necessary modules to execute the operating system sufficiently.

In one embodiment, the runtime environment 20 is implemented as a software system. In this case, the runtime environment 20 runs on the execution system 14. In a further embodiment, the runtime environment 20 is a Java virtual machine. In another embodiment, the runtime environment 20 can be other type of runtime system (e.g., small talk runtime system). Alternatively, the runtime environment 20 can be implemented in other ways (e.g., as a firmware system). FIG. 2 shows in block diagram the functional structure of the runtime environment 20, which will be described in more detail below.

Referring to FIG. 2, the runtime environment 20 includes a main engine 21, a synchronization module 22, a garbage collector 24, the locking module 23, and the lock re-reservation module 25. The locking module 23 is within the synchronization module 22 and the lock re-reservation module 25 is within the garbage collector 24, in one embodiment. Alternatively, the lock re-reservation module 25 may not be within the garbage collector 24. Instead, the lock re-reservation module 25 may be within other modules (e.g., the main engine 21) of the runtime environment 20.

The main engine 21 is employed as the main core of the runtime environment 20. The main engine 21 monitors compilation and execution of the intermediate language code, and invokes the modules 22-25 when required. Thus, the main engine 21 is the coordinator of the modules 22-25.

In addition, the main engine 21 includes a class loader (not shown in FIG. 2). The class loader is used to load classes. The main engine 21 also includes class libraries (not shown in FIG. 2). The class libraries are used to store shared classes. The main engine 21 also includes a just-in-time (JIT) compiler (not shown in FIG. 2). The JIT compiler compiles the intermediate language code 13 (FIG. 1) to generate native or machine code at runtime that is executed by the execution system 14 (FIG. 1). The term “just-in-time” means that the just-in-time compiler compiles or translates each method or class when it is actually used for execution into native code. The main engine 21 may include an interpreter (also not shown in FIG. 2) that may run in parallel with the JIT compiler to provide interpreted (but not optimized) native code while the JIT compiler spends time generating optimized native code.

The main engine 21 also includes a memory manager (not shown in FIG. 2). The memory manager is used to manage a specific memory space within the memory referred to as heap or heap space. The memory manager includes a heap allocation module (not shown in FIG. 2) and the garbage collector 24 (shown in FIG. 2). The heap allocation module is used to allocate objects to the heap space in the memory. The garbage collector 24 is used to reclaim memory space in the heap used by objects that are no longer referenced by an application or thread. Additionally, the garbage collector 24 also may move objects to reduce heap fragmentation.

The synchronization module 22 is used to synchronize multiple threads during program execution to prevent contention among threads for shared objects. The synchronization module 22 performs all synchronization functions except the locking and lock reservation functions that are performed by the locking module 23. Likewise, the garbage collector 24 performs all garbage collection functions with the exception of the lock re-reservation. The lock re-reservation module 25 performs the lock re-reservation function. All of the modules 21, 22, and 24 of the runtime environment 20 can be implemented using known technologies.

Because the source code program 11 (FIG. 1) is a multi-threaded program, each of the globally accessible objects within the source code program 11 includes a lock for synchronization purpose. The locking module 23 of FIG. 2 is used to perform two main functions of synchronization. The first one is to lock an object when a thread external to the object attempts to access the object. The second function is to reserve the lock of the object for the requesting thread when the requesting thread is determined to want to repeatedly access the object. FIG. 5 shows, as an example, the layout of a globally accessible object 60 that contains a lock that can be operated on by the locking module 23.

As can be seen from FIG. 5, the object 60 includes an object header 61 and an object body 62. The body 62 contains program code of the object 60. The header 61 is a synchronization header that contains synchronization information about the object 60. In particular, the header 61 includes a lock in the form of lock-word 70.

As can be seen from FIG. 5, the lock-word 70 includes a thread ID (TID), field 71, a recursion count (RCNT) field 72, and a lock reservation (LRV) field 73. The TID field 71 indicates which external thread is currently reserving the lock of the object 60. The RCNT field 72 indicates whether that thread has “acquired” the lock of the object 60. Here, reserving means that the object is only reserved for (but not locked by) the requesting thread while acquiring means that the object is actually locked by the requesting thread. The LRV field 73 indicates whether the lock has been reserved for the requesting thread or not.

In one embodiment, the LRV field 73 is a one-bit indication. In alternative embodiments, the LRV field 73 may contain more than one bit.

In one embodiment, the lock-word 70 also includes a lock re-reservation (RRB) field 74. In this embodiment, the RRB field 74 is a one-bit indication. In alternative embodiments, the RRB field 74 may be in other parts of the header 61 outside the lock-word 70. The RRB field 74 and its use will be described in more detail below, in connection with the lock re-reservation module 25 of FIG. 2.

FIG. 6 shows all the reservation states the lock-word 70 of FIG. 5 indicates. As can be seen from FIG. 6, the lock states include the anonymously reserved state (i.e., state 90), the reserved-but-not-locked state (i.e., state 91), the reserved-and-locked state (i.e., the state 92), and the unreserved state (i.e., state 93). In the anonymously reserved state 90, both the TID and RCNT fields of the lock-word are set at “0” while the LRV bit is set at “1”. In the reserved-but-not-locked state 91, the TID field stores the requesting thread ID while the RCNT field remains at “0”. In the reserved-and-locked state 92, the RCNT field is incremented to reflect that the lock is locked by the locking thread at least once. In the unreserved state 93, the TID and RCNT fields are defined by the base lock and the LRV bit is set at “0” to reflect that the lock is not reserved. Here, the term “base lock” refers to the information about the current requesting thread that has locked the object. FIG. 6 also shows the state transitions among various states. The solid arrows indicate valid state transitions or changes by the locking module 23 of FIG. 2. In one embodiment, the lock-word 70 moves from the anonymously reserved state 90 to the reserved-and-locked state 92 via the reserved-but-not-locked state 91. The lock-word 70 can then move between the states 91-92. In another embodiment, the lock-word 70 moves directly from the anonymously reserved state 90 to the reserved-and-locked state 92. The lock-word 70 can then move between the states 91-92. The dotted arrow indicates the valid state transition not by the locking module 23, but by the lock re-reservation module 25. This will be described in more detail below.

Referring back to FIG. 2, the locking module 23 can employ one of two locking sequences to lock an object. One is the relatively slow and more expensive base locking sequence on top of which the lock reservation system (including the locking module 23 and the lock re-reservation module 25) is built. The other is the relatively fast and inexpensive locking sequence. The base locking sequence is known and may be implemented by any known base locking sequence. The locking module 23 is functionally located on top of the base locking sequence. The relatively fast and inexpensive locking sequence is a subset of the base locking sequence because it assumes that the object is to be locked by the same requesting thread that has previously locked the object. This means that the fast and inexpensive locking sequence skips many operations (e.g., initialization and housekeep) of the base locking sequence, thus becoming relatively fast and inexpensive.

The lock reservation function of the locking module 23 allows the locking module 23 to quickly lock the object for the requesting thread using the fast and inexpensive locking sequence when the requesting thread again attempts to access the object that has been reserved for the requesting thread. This will be described below, also in conjunction with FIGS. 2 and 6.

Referring to FIGS. 2 and 6, when an object is first created, its lock is not reserved for any thread. In this case, the lock placed in the anonymously reserved state (e.g., state 90) which causes the LRV bit of the lock-word of the object to be “1”. When a thread of execution attempts to access the object, the locking module 23 reserves the object's lock for the requesting thread. This moves the lock to the reserved-but-not-locked state (e.g., state 91) for that requesting thread. In this state, the locking module 23 reserves the lock for the requesting thread by storing the thread ID of the requesting thread in the TID field of the lock-word of the object. At this time, the requesting thread has not acquired the lock and cannot access the object.

When the requesting thread accesses the object, the locking module 23 places the lock in the reserved-and-locked state (e.g., state 92) by incrementing the RCNT field of the lock-word to be greater than “0”. In this state, the lock is both reserved for and locked by the requesting thread. When the lock of the object is in this state, the locking module 23 can lock the object (or acquire the lock of the object) using the fast and inexpensive locking sequence.

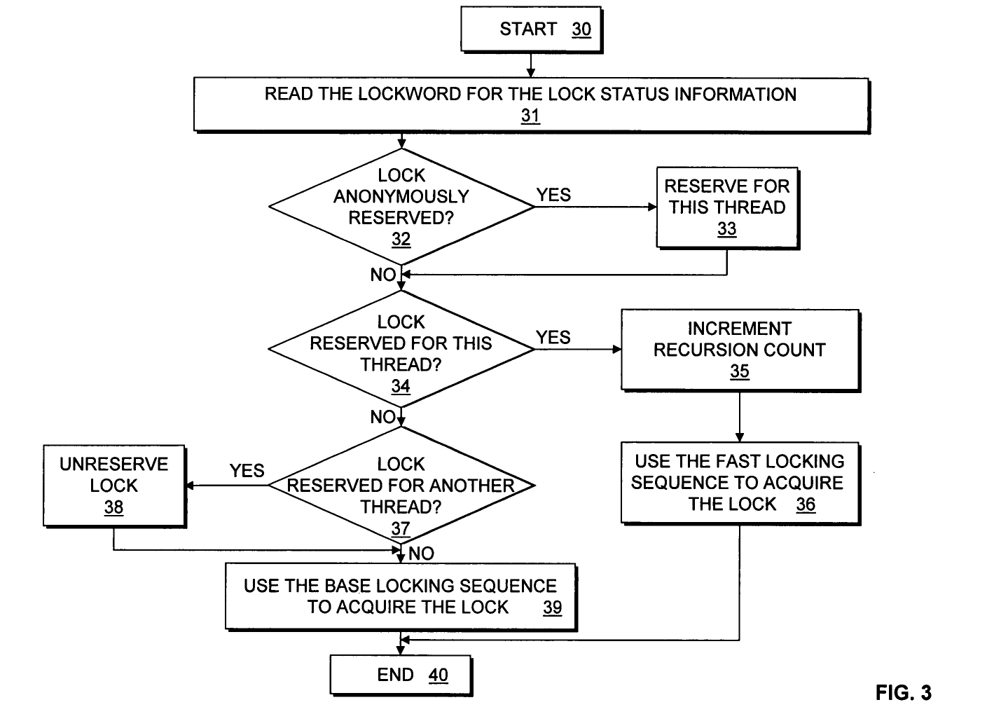

When another thread attempts to access the object, the locking module 23 cancels the reservation by setting the LRV bit to “0” in the lock-word. Once the lock is moved into the unreserved state (e.g., state 93), the locking module 23 can no longer move the lock to other reserved states. FIG. 3 shows the locking and lock reservation process performed by the locking module 23, which is described in more detail below.

As can be seen from FIG. 3, the locking and lock reservation process starts with obtaining the lock status information from the lock-word of the object to be locked (i.e., block 31 in FIG. 3). The locking module 23 reads the lock-word to obtain the lock status information.

At 32, the locking module 23 determines whether the lock status of the object to be locked is in the anonymously reserved state. The locking module 23 determines if the lock is in the anonymously reserved state by checking the lock status information from the lock-word of the object. As described above in connection with FIGS. 5-6, the TID field and the RCNT field of the lock-word will both be set to “0” while the LRV bit is set to “1” when the lock is in the anonymously reserved state (see the state 90 in FIG. 6). If it is determined that the lock is already in the anonymously reserved state, the process moves to the block 33. If the answer is NO, the operation indicated in the block 33 is skipped.

At 33, the locking module 23 reserves (but not locks or holds) the lock of the object for the locking (or requesting) thread. This means that the lock of the object is moved to the reserved-but-not-locked state. As described above, in this state, the lock is reserved for but not locked by the requesting thread. Also as described above, once the lock is reserved for the requesting thread, the fast and inexpensive locking sequence can be used when the requesting thread wants to acquire the lock of the object (i.e., actually lock the object). The locking module 23 does the reservation by changing the TID field of the lock-word. For example, if the requesting thread is a Thread A, then the locking module 23 changes the TID field to “A” to move the lock to the reserved-but-not-locked state (see the state 91 in FIG. 6).

At 34, the locking module 23 determines whether the lock is already reserved for this requesting thread. The locking module 23 determines this from the lock status information obtained from the lock-word. If the locking module 23 determines that the lock has already been reserved for this locking thread, the locking module 23 moves to perform the operations indicated in the blocks 35 and 36 where the locking module 23 can lock (or acquire the lock of) the object using the fast and inexpensive locking sequence. If the answer is NO (meaning that the lock was not reserved for the locking thread), the operations indicated in the blocks 35 through 36 are skipped and the operations indicated in the block 37 through 39 are performed where the locking module 23 needs to unreserve the lock so as to ensure that the slow and expensive base locking sequence be used to lock the object for the requesting thread.

At 35, the locking module 23 increases the recursion count (i.e., the RCNT field) within the lock-word of the lock. This means that the lock has moved to the reserved-and-locked state and the value in the RCNT field is greater than “0” (see the state 92 in FIG. 6). In this state, the lock is both reserved for and locked by the requesting thread through the locking module 23.

At 36, the locking module 23 uses the fast and inexpensive locking sequence to acquire the lock.

At 37, the locking module 23 determines whether the lock has been reserved for another thread. This is done by, for example, comparing the value in the TID field of the lock-word with the ID of the locking thread. If they do not match, it means that the object has already been reserved for another thread. In this case, the object may be in the reserved-but-not-locked state (e.g., the state 91 of FIG. 6) or in the reserved-and-locked state (e.g., the state 92 of FIG. 6) for the other thread. If it is determined that the lock has been reserved for another thread, the locking module 23 then executes the operation indicated in the block 38 to un-reserve the lock. If the answer is NO, the operation indicated in the block 38 is skipped.

At 38, the locking module 23 un-reserves the lock. This means that the locking module 23 changes the lock-word of the lock to the unreserved state (see the state 93 in FIG. 6) by changing the LRV bit to “0”.

At 39, the locking module 23 uses the base locking sequence to acquire the lock.

Referring back to FIG. 2, the lock re-reservation module 25 is used to re-reserve the lock from the unreserved state to the anonymously reserved state such that the locking module 23 can again be allowed to employ the fast and inexpensive locking sequence to lock an object when the lock of that object has moved to the unreserved state. The lock re-reservation module 25 does this re-reservation at each garbage collection cycle.

For example and as can be seen from FIGS. 2 and 5-6, when an object is in the unreserved state (e.g., the unreserved state 93), the locking module 23 can only lock the object using the slow and expensive locking sequence during the object's lifetime, even after the object has moved to the unreserved state. As described above, the locking module 23, however, cannot move the lock out of the unreserved state. But the lock re-reservation module 25 can re-reserve the lock from the unreserved state to the anonymously reserved state (e.g., the state 93 in FIG. 6) such that the fast and inexpensive locking sequence can continue to be available to the locking module 23 during the object's lifetime. To perform the lock re-reservation, the lock re-reservation module 25 determines whether the lock has moved to the unreserved state. If the lock has moved to the unreserved state, then the lock re-reservation module 25 re-reserves the lock to the anonymously reserved state.

The lock re-reservation module 25 also avoids reservation thrash during the lock re-reservation. This is achieved by employing the lock re-reservation indication (i.e., the re-reservation bit (RRB) 74 in FIG. 5). If the RRB has been set, then the lock re-reservation module 25 does not perform any re-reservation operation even though the lock is determined to be in the unreserved state. In other words, to perform the lock re-reservation, the lock re-reservation module 25 first determines whether (1) the lock has been moved from one of the reserved states to the unreserved state and (2) the object's RRB has been set. If (1) the lock has moved to the unreserved state and (2) the object's RRB has been not set, then the lock re-reservation module 25 re-reserves the lock to the anonymously reserved state. Otherwise, the lock re-reservation module 25 does not move the lock out of the unreserved state. This prevents any reservation thrash from occurring.

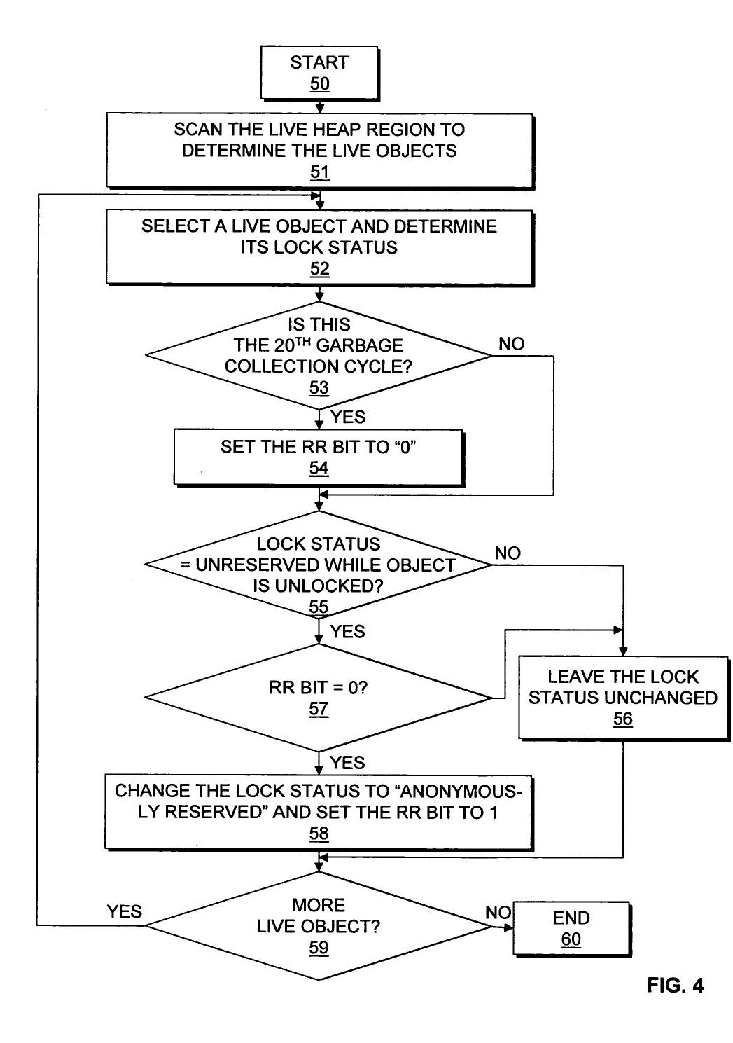

The object's RRB can be reset after certain predetermined number of garbage collection cycles since the latest re-reservation phase. This can be done by having the lock re-reservation module 25 determine if the object has gone through that predetermined number of garbage collection cycles (e.g., twenty garbage collection cycles) since the latest re-reservation phase. If the object has gone through the predetermined number of garbage collection cycles since the latest re-reservation phase, the lock re-reservation module 25 resets the re-reservation indication of the lock. The re-reservation indication does not affect the operation of the locking module 23 during the locking and lock reservation operation because the locking module 23, when reserving and unreserving the lock, does not consider the RRB at all. FIG. 4 shows the lock re-reservation process performed by the lock re-reservation module 25 of FIG. 2 in accordance with one embodiment of the present invention, which will be described in more detail below.

As can be seen from FIG. 4, the lock re-reservation process starts with lock re-reservation module 25 scanning (i.e., block 51) the live heap region of memory to determine which are live objects during a garbage collection cycle. Here, live objects mean those objects that are not going to be garbage collected by the garbage collector 24 of FIG. 2 during garbage collection. Alternatively, the garbage collector 24 of FIG. 2 (instead of the lock re-reservation module 25) may perform the scanning during a garbage collection cycle.

At 52, a live object is selected and its lock status is determined. In accordance with one embodiment of the present invention, the lock re-reservation module 25 selects the live object and determines the lock status of the selected live object. The lock re-reservation module 25 determines the lock status of the lock of the selected live object by reading the information stored in the lock-word of the selected live object.

At 53, it is determined whether the current garbage collection cycle is the twentieth garbage collection cycle since the latest re-reservation phase. Here, the specific number is given for illustration purposes. Thus, this number can be changed to other values. In accordance with one embodiment of the present invention, the lock re-reservation module 25 determines whether the current garbage collection cycle is the twentieth cycle since the latest re-reservation phase. If the determination is YES, then the process moves to the operation indicated in the block 54 wherein the re-reservation bit (i.e., RRB) of the lock is reset. This mechanism allows the lock to be re-reserved more than once (i.e., from the unreserved state to the anonymously reserved state) without causing reservation thrash. If the answer is NO, then the operation in the block 54 is skipped.

At 54, the re-reservation bit RRB in the lock-word is set to “0” (i.e., reset). In accordance with one embodiment of the present invention, the lock re-reservation module 25 sets the RRB bit to “0”.

At 55, it is determined whether the lock is in the unreserved state and the object is unlocked. According to one embodiment of the present invention, the lock re-reservation module 25 makes the determination by checking the lock-word of the object. If the answer is NO, it means that the lock cannot be re-reserved. In this case, the lock re-reservation module 25 performs the operation indicated at the block 56. If the answer is YES, then the lock re-reservation module 25 performs the operation indicated at the block 57.

At 56, the status of the lock is left unchanged. According to one embodiment of the present invention, the lock re-reservation module 25 handles this operation. The re-reservation process then moves to the operation indicated in the block 59.

At 57, it is determined whether the re-reservation bit RRB has been reset (i.e., set at “0”). According to one embodiment of the present invention, the lock re-reservation module 25 makes this determination by checking the RRB field (e.g., the RRB field 74 in FIG. 5) in the header of the object. If the answer is NO, it means that the lock cannot be re-reserved. In this case, the operation at the block 56 is performed. If the answer is YES, it means that the re-reservation can be rendered and the lock re-reservation module 25 performs the re-reservation operation indicated at the block 58.

At 58, the lock status is changed to anonymously reserved state and the RRB is set (i.e., set to “1”). This is the lock re-reservation operation. According to one embodiment of the present invention, the lock re-reservation module 25 performs this operation.

At 59, it is determined if there are more live objects waiting to be checked. According to one embodiment of the present invention, the lock re-reservation module 25 performs this function by checking the scanned list of live objects. If the answer is YES, then the process moves to the operation indicated at the block 52. Otherwise, the process ends at the block 60.

FIGS. 3 and 4 are flow charts illustrating a locking and lock reservation process and a lock re-reservation process according to embodiments of the present invention. Some of the procedures illustrated in the figures may be performed sequentially, in parallel or in an order other than what is described. It should be appreciated that not all of the procedures described may be required, that additional procedures may be added, and that some of the illustrated procedures may be substituted with other procedures.

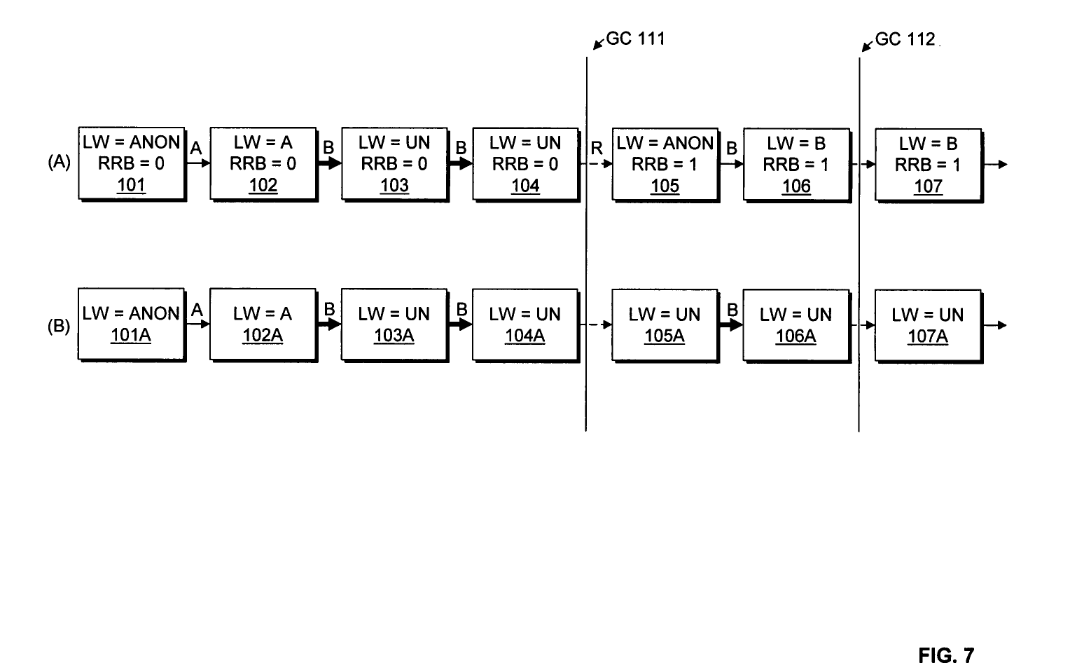

FIG. 7 shows a state-by-state comparison between a lock state transition flow (a) implemented with the lock re-reservation module 25 of FIG. 2 in accordance with one embodiment of the present invention and a lock state transition flow (b) implemented without the lock re-reservation module of FIG. 2. FIG. 7 shows an example of program execution in which an object is first locked by a Thread A and then subsequently and repeatedly by a Thread B. This means that in the example shown in FIG. 7, both state transition flows employ the same threads (e.g., Thread A and Thread B) during program execution and the Thread A performs the first locking operation on the object and the Thread B performs all subsequent locking operation on the object.

In FIG. 7, “GC” indicates a garbage collection cycle. “LW” indicates the lock status information of the lock-word, which indicates the reservation state (e.g., anonymously reserved, unreserved, reserved-but-not-locked, or reserved-and-locked) of the lock of the object. “RRB” is the re-reservation indication bit for the lock. Program execution proceeds in time from left to right in FIG. 7. The letter A or B above an arrow in FIG. 7 indicates a locking or unlocking operation by the requesting or acquiring Thread A or B while the letter “R” about a dotted arrow indicates a lock re-reservation operation performed by the lock re-reservation module 25 of FIG. 2 in accordance with one embodiment of the present invention to move the lock from the unreserved state to the anonymously reserved state. A thick arrow indicates that the locking or unlocking operation employs the slow and expensive base locking sequence while a thin arrow indicates that the locking or unlocking operation employs the fast and inexpensive locking sequence. A dotted line without any letter indicates the same state transition (i.e., no state change).

As can be seen from FIG. 7, the lock re-reservation module 25 of FIG. 2 re-reserves the lock by changing the lock status from the unreserved state (e.g., the state 104) to the anonymously reserved state (e.g., the state 105) when the lock reservation module 25 determines that the lock is in the unreserved state (and when the RRB is not set). This allows the subsequent locking operation to employ the fast and inexpensive locking sequence (see the thin arrow between the states 105 and 106) while in contrast, the locking operation in the state transition flow (b) still employs the slow and expensive base locking sequence (see the solid arrow between the states 105a and 106a). This is due to the fact that at the state 105a, the lock status is not changed from the unreserved state to the anonymously reserved state. It remains in the unreserved state. This shows that using the lock re-reservation module 25 to re-reserve an object's lock, the locking operation for that object can frequently converge to the fast and inexpensive locking sequence during the lifetime of the object, thus saving significant synchronization time.

In the foregoing specification, embodiments of the present invention have been described with reference to specific exemplary embodiments thereof. It will, however, be evident that various modifications and changes may be made thereto without departing from the broader spirit and scope of the embodiments of the present invention. The specification and drawings are, accordingly, to be regarded in an illustrative rather than restrictive sense.

1. A runtime environment, comprising:
a locking module to reserve a lock of an object among a plurality of reserved states when an external thread wants to access the object, and to unreserve the lock to an unreserved state when another external thread wants to access the object; and
a lock re-reservation module to re-reserve the lock from the unreserved state to a first reserved state when the lock is in the unreserved state.

2. The runtime environment of claim 1, wherein the lock re-reservation module re-reserves the lock from the unreserved state to the first reserved state when the lock is in the unreserved state and when a re-reservation indication of the lock is not set.

3. The runtime environment of claim 2, wherein the re-reservation indication is a one-bit indication within a lock-word of the object.

4. The runtime environment of claim 2, wherein the re-reservation indication is a one-bit indication within a header of the object.

5. The runtime environment of claim 2, further comprising a garbage collector that resets the re-reservation indication after the object has gone through a predetermined number of garbage collection cycles since a latest re-reservation phase.

6. The runtime environment of claim 5, wherein the predetermined number of garbage collection cycles since the latest re-reservation phase is twenty.

7. The runtime environment of claim 2, wherein the first reserved state is an anonymously reserved state.

8. The runtime environment of claim 2, wherein the locking module records state changes of the lock in a lock-word of the object that includes a lock reservation indication, wherein the locking module does not consider the re-reservation indication in reserving and unreserving the lock.

9. A method of re-reserving a lock of an object, comprising:
determining if (1) the lock has been moved from one of a plurality of reserved states to an unreserved state and (2) a re-reservation indication of the lock has been set; and
re-reserving the lock from the unreserved state to a first reserved state if (1) the lock is in the unreserved state and (2) the re-reservation indication of the lock has been not set.

10. The method of claim 9, further comprising
determining if the object has gone through a predetermined number of garbage collection cycles since a latest re-reservation phase; and
resetting the re-reservation indication of the lock if the object has gone through a predetermined number of garbage collection cycles since the latest re-reservation phase.

11. The method of claim 10, wherein the predetermined number of garbage collection cycles since the latest re-reservation phase is twenty.

12. The method of claim 9, wherein the re-reservation indication is a one-bit indication within a lock-word of the object.

13. The method of claim 9, wherein the re-reservation indication is a one-bit indication within a header of the object.

14. The method of claim 9, wherein the first reserved state is an anonymously reserved state.

15. The method of claim 9, wherein the lock reservation indication is not considered by a locking module when reserving and unreserving the lock.

16. An article of manufacture comprising a machine accessible medium including sequences of instructions, the sequences of instructions including instructions which when executed causes the machine to perform:
determining if (1) a lock has been moved from one of a plurality of reserved states to an unreserved state and (2) a re-reservation indication of the lock has been set; and
re-reserving the lock from the unreserved state to a first reserved state if (1) the lock is in the unreserved state and (2) the re-reservation indication of the lock has been not set.

17. The article of manufacture of claim 16, further comprising sequences of instructions including instructions which when executed performs:
determining if an object has gone through a predetermined number of garbage collection cycles since a latest re-reservation phase; and
resetting the re-reservation indication of the lock if the object has gone through a predetermined number of garbage collection cycles since the latest re-reservation phase.

18. The article of manufacture of claim 17, wherein the predetermined number of garbage collection cycles since the latest re-reservation phase is twenty.

19. The article of manufacture of claim 16, wherein the re-reservation indication is a one-bit indication within a lock-word of the object.

20. The article of manufacture of claim 16, wherein the re-reservation indication is a one-bit indication within a header of the object.

21. The article of manufacture of claim 16, wherein the first reserved state is an anonymously reserved state.

22. The article of manufacture of claim 16, wherein the lock reservation indication is not considered by a locking module when reserving and unreserving the lock.
